(19) United States
(12) Patent Application Publication
(10) Pub. No.: US 2005/0106085 A1
(43) Pub. Date: May 19, 2005

(54) Reactor for treating a gas flow with plasma, particularly exhaust gases produced by the internal combustion engine in a motor vehicle

(76) Inventors: Sabine Calvo, Les Clayes Sous Bois (FR); Frederic Dionnet, Berville En Roumois (FR); Stephane Eymerie, Pacy Sur Eure (FR); Yvane Lendresse, Rueil Malmaison (FR); Lionel Robin, Rouen (FR); Pierre Vervisch, Rouen (FR)

Correspondence Address: JACOBSON HOLMAN PLLC, 400 SEVENTH STREET N.W., SUITE 600, WASHINGTON, DC, 20004, US

(21) Appl. No.: 10/504,157

(22) PCT Filed: Feb. 27, 2003
(86) PCT No.: PCT/FR03/00635

(30) Foreign Application Priority Data
Feb. 27, 2002 (FR) 02/02475

(51) Int. Cl. B01J 19/08; B01J 19/12

(52) U.S. Cl. 422/186.04

(57) ABSTRACT

The invention relates to a reactor comprising a reactor body (8) with a generally elongated form made from a dielectric material and crossed by several parallel channels (10) extending longitudinally within the body. Electrodes (14) are provided for generation of discharge coronas in the body for initiating the treatment of gas flow. According to the invention, each of the electrodes (14) is arranged in a channel (10), forming part of the several channels (10) and extending over at least a part of the length of the respective channel.

The present invention relates to a reactor for the plasma treatment of a gas flow particularly a flow of exhaust gases produced by the internal combustion engine in a motor vehicle.

Regulations on emissions from automobile vehicles essentially relate to four pollutants, namely unburned hydrocarbons (HC), carbon monoxide (CO), nitrogen oxides (NOx), and solid particles.

In the case of an internal combustion engine operating with excess oxygen (a petrol engine burning a lean mixture or a diesel engine), emissions of HC and CO are reduced using an oxidation catalytic converter operating at high temperature and converting them practically entirely into carbon dioxide (CO₂).

Emissions of NOx may be captured and stored in a NOx trap, which must be regenerated periodically by temporarily increasing the richness of the fuel mixture.

Moreover, the particles produced mostly by diesel engines are also treated by means of a trap that has to be regenerated. Regeneration is effected by oxidation of the accumulated partides (soot) using excess oxygen. The starting temperature of the corresponding reaction is relatively high (>600° C.), with the result that a strategy of assistance by means of engine management (for example post-injection or staggered injection) is necessary to enable regeneration regardless of the engine operating conditions.

An alternative solution is to combine the strategy of assistance through engine management with the addition of catalytic additives to the fuel to reduce the combustion temperature by around 100 degrees below the aforementioned temperature of 600° C. Another alternative to the first solution is to use a particulate filter impregnated with a catalytic phase.

These standard processes for treating emissions are complex and significantly increase the cost of the exhaust system, and their efficiency varies as a function of the vehicle operating conditions.

To alleviate these problems, it is already known in the art to use a non-thermal plasma technology that consists in forming metastable species, free radicals and highly reactive ions by collisions between gas molecules and highly energetic electrons produced by an electrical discharge, without increasing the temperature of the gaseous medium.

The discharge may be obtained by applying a potential difference of several hundred kilovolts between electrodes to generate electrical pulses whose intensity varies according to the mode of excitation (from around 100 microamperes to a few hundred amperes, for example). The discharges cause the formation of a large number of molecules and species such as NO₂, ozone (O₃), radicals, partially oxidized hydrocarbons, activated solid carbon containing species such as soot, etc. These molecules and species, which are more reactive than the unprocessed products emitted into the exhaust system, may be converted into non-polluting species by appropriate treatment (for example by passing them through a catalytic converter).

A reactor based on the above technology is described in the document WO 00/51714, for example. In this case, the reactor comprises a hollow dielectric material cylindrical body in which passages for the gases to be treated are provided in an intermediate region of the dielectric body and electrodes are provided on a peripheral surface and on the surface of an internal axial bore. This arrangement essentially has the drawback that the electrodes are very far apart, with the result that the voltage to be applied must be very high. Moreover, the stimulating effects of the electric field cannot be uniform either, because the space between the electrodes is occupied in a non-uniform manner by the ceramic material and the passages through which the treated gases flow.

One solution to this problem is described in another document WO 00/49 278. In this case, the reactor comprises a cylindrical enclosure in which the gases to be treated are able to circulate axially through an array of superposed beds of alternately positive and negative wire electrodes, the high voltage being applied to the respective electrode beds to form respective electric fields between them.

Each electrode is passed through a series of axially aligned cylindrical pins, contiguous pins in the same radial plane being braced by a support grid fixed to the enclosure.

This arrangement undoubtedly makes the electric field more uniform and brings the electrodes of opposite polarity closer together, with the corollary that the voltage may be reduced, but is extremely complex and fragile, with the result that it significantly increases the cost of manufacture and introduces a risk of deterioration in use.

An object of the invention is to provide a reactor of the general type indicated that is free of the drawbacks of the prior art.

The invention therefore provides a reactor for the plasma treatment of gas flows, in particular for treating exhaust gases produced by an internal combustion engine of an automobile vehicle, the reactor comprising a generally elongate reactor body made from a dielectric material through which pass a plurality of parallel longitudinal passages, entry and exit means for conducting the flow of gas to be treated through said body, and electrodes adapted to create corona discharges in said body to stimulate the treatment of said gas flow therein, which reactor is characterized in that each of said electrodes is disposed in a passage of said plurality of passages and extends over at least a portion of the length of the corresponding passage.

Thanks to these features, a reactor is obtained having a robust and compact structure in which a homogeneous electrical field may be generated to encourage a uniform distribution of the electrical discharges, enabling homogeneous treatment of the gases to be treated. Furthermore, the invention enables the use of monolithic carcasses conventionally used in the exhaust gas treatment art without major modifications.

According to other advantageous features of the invention:
the passages are disposed side by side in said reactor body in superposed longitudinal planes, said electrodes are arranged in at least two parallel electrode beds, one of which comprises electrodes adapted to be connected to one pole of a high-voltage supply and the other of which comprises electrodes adapted to be connected to the other pole of said high-voltage supply, and said electrode beds are offset from each other by a predetermined distance;
the ends of the electrodes of the same electrode bed situated on the same front face of said reactor body are connected in common to an electrically conductive bar connected to the corresponding pole of said high-voltage supply;
said connecting bar is disposed in a groove formed in an end face of the reactor body;
said groove receiving said connecting bar is pointed using a dielectric material;
the end of each electrode opposite said connecting bar is buried in a dielectric material plugging the passage receiving that electrode at the corresponding end;
the reactor comprises at least three electrode beds and the electrode bed or beds connected to one of the poles of said high-voltage supply is or are disposed between two electrode beds connected to the other pole of said high-voltage supply;
the electrodes of the two superposed adjacent electrode beds are disposed in passages aligned in planes perpendicular to these electrode beds;
the electrodes of two adjacent superposed electrode beds are inserted in respective passages arranged in a quincunx;
said electrodes are rods, preferably of circular general section;
the rods of at least some of said electrodes are provided with asperities or reliefs;
the asperities or reliefs on the electrodes extend therealong in accordance with a helicoidal profile;
said reactor body is made from a ceramic such as cordierite.

The invention also provides a particulate filter characterized in that it comprises a reactor as defined hereinabove and the passages of said reactor body with no electrodes are alternately plugged at one or the other face of said body.

In this particulate filter, passages situated in two adjacent parallel planes in said reactor body may be plugged at one or the other face of said body, respectively. However, adjacent passages situated in a common plane of said reactor body may also be alternately plugged at one and the other face of said body. Moreover, the walls of the passages may be coated with a catalytic material.

The invention further provides a catalytic converter characterized in that it comprises a reactor as defined hereinabove, characterized in that the passages of the reactor body with no electrodes are open on both faces of the reactor body.

Other features and advantages of the present invention will become apparent in the course of the following description which is given by way of example only and with reference to the appended drawings, in which:

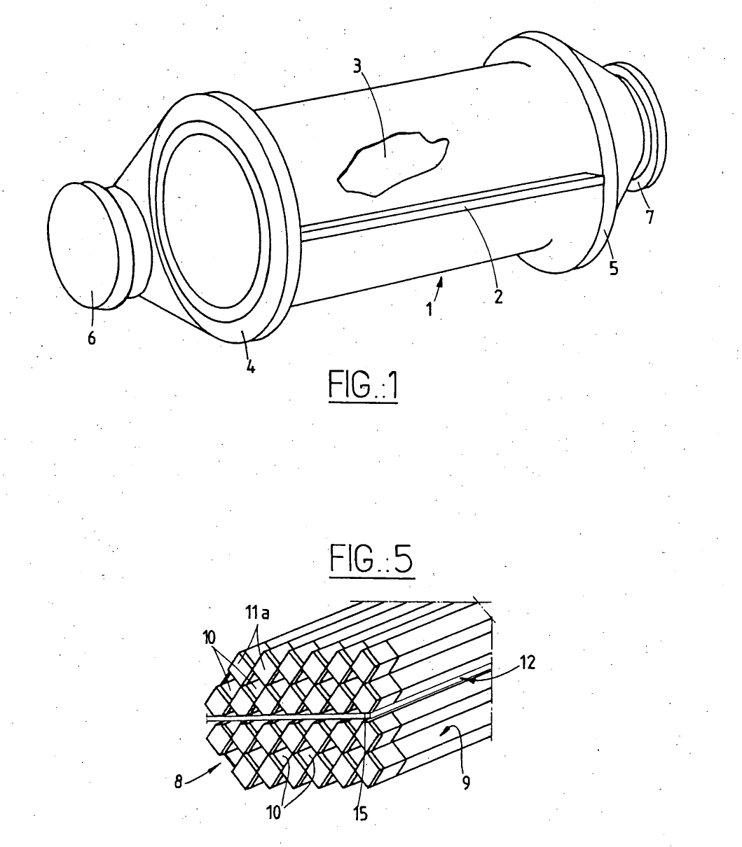

FIG. 1 is a partly cut-away general exterior perspective view of a reactor according to the invention;

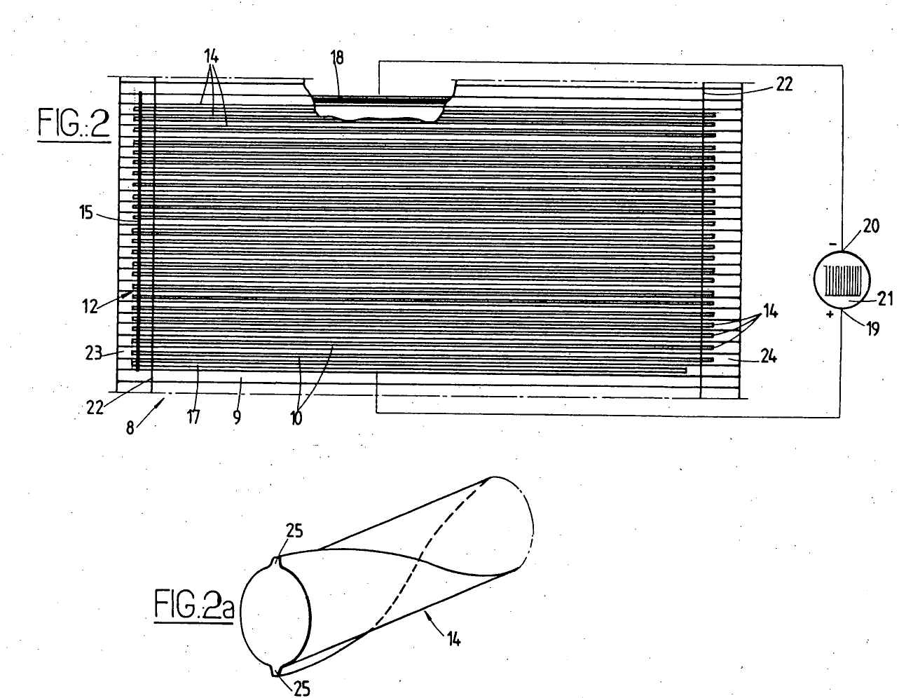

FIG. 2 is a view in partial longitudinal section of a reactor body according to the invention placed in the reactor enclosure represented in FIG. 1, more particularly constituting a regeneration particulate filter;

FIG. 2a is a perspective view to a larger scale of a detail of one electrode of the reactor;

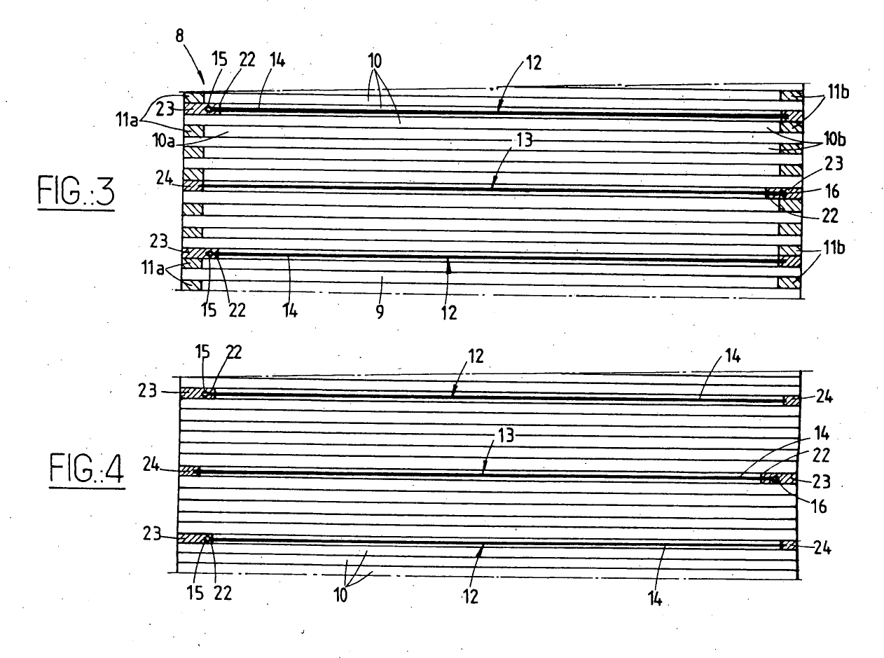

FIG. 3 is a view in partial longitudinal section of the reactor body from FIG. 2, the section plane being an electrode plane at 90° to the FIG. 2 view;

FIG. 4 is a view in section analogous to that of FIG. 3 of a reactor body intended more particularly to be used as a catalytic converter;

FIG. 5 is a partial perspective view of one end of a reactor body according to the invention showing one example of the disposition and shape of the passages;

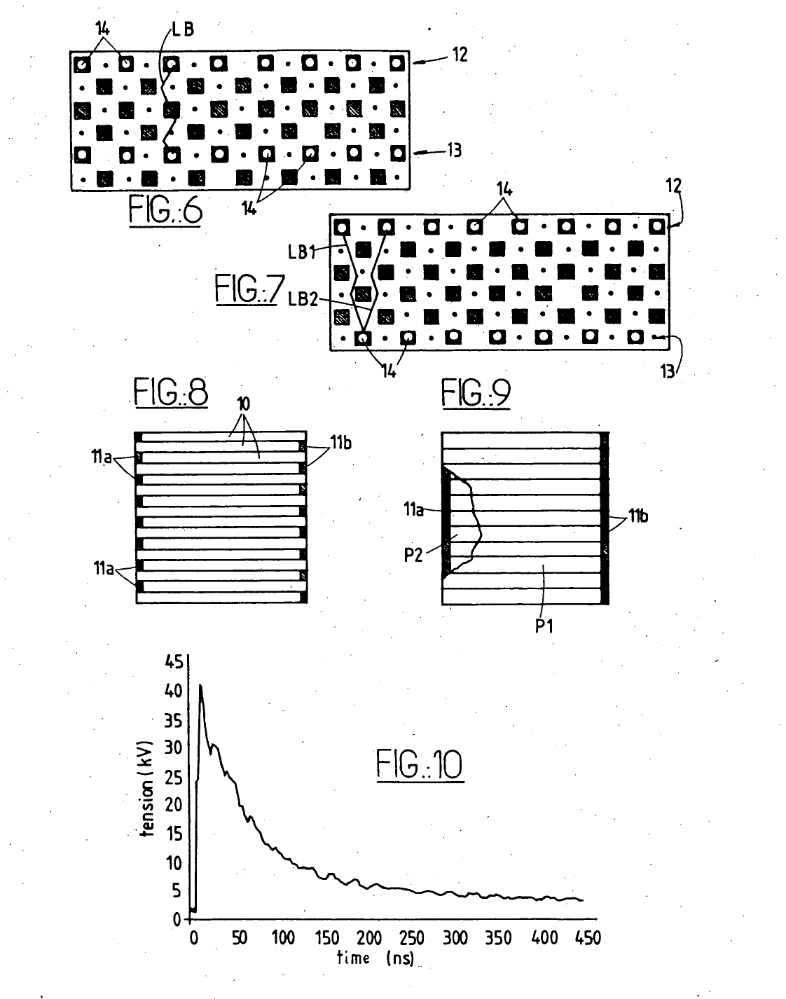

FIGS. 6 and 7 show other arrangements of the electrodes in a reactor body more particularly intended to be used as a regeneration particulate filter;

FIGS. 8 and 9 show two examples of the plugging of the passages of the reactor body; and

FIG. 10 shows one example of voltage pulses that may be applied between the electrode beds of opposite polarity.

FIG. 1 is an exterior perspective view of a reactor according to the invention, which may be used as a regeneration particulate filter or as a catalytic converter. There is seen a reactor enclosure 1, here of cylindrical shape and preferably made from sheet steel, possibly stainless steel, joined by two edges along a crimped joint 2, for example. This enclosure is internally lined with a coating 3 formed of an insulator such as thermal wool, for example of the INTERAM type. The enclosure 1 is closed at both ends by flanges 4 and 5 provided with respective connectors 6 and 7 for connecting the reactor into an exhaust system (not shown). Note that the FIG. 1 embodiment has a reactor of generally cylindrical shape, but that this is not limiting on the invention, as other general shapes analogous to the usual shapes for reactors in the automotive industry may be envisaged.

Refer now to FIGS. 2, 3 and 5, which represent one preferred embodiment of a reactor body 8 according to the invention adapted to be placed in the reactor enclosure 1 inside the coating 3, which provides a seal, thermal insulation and protection against vibration of the exhaust system. FIGS. 2 and 3 are partial views in longitudinal section planes at 90° to each other. The resulting reactor body 8 is used to construct a regeneration particulate filter in the manner explained in more detail hereinafter.

The reactor body 8 is formed of a monolithic carcass 9 of generally elongate shape within which are provided passages 10 parallel to the longitudinal direction of the body 8. In the embodiment represented, when seen in the cross section of the carcass, these passages 10 comprise a honeycomb array and the section of each passage 10 is square (see FIG. 5). This example is not limiting, and other dispositions of the passages relative to each other and other passage sections, for example hexagonal sections, may be envisaged.

The monolithic carcass 9 is preferably made of a material having a very low dielectric conductivity and the ability to withstand high temperatures. A ceramic material such as cordierite is very suitable. The carcass 9 may be produced by any method known in the art of catalytic converters and/or particulate filters. The walls of the passages 10 may where applicable be coated with a catalytic material.

The embodiment shown in FIGS. 2 and 3 constitutes a reactor body 8 for a particulate filter and the passages 10 comprise plugs 11a and 11b at respective ends of the reactor body, it being understood that a given passage, for example the passage 10a (FIG. 3), has a plug 11a at the inlet end of the reactor body 8 (on the left in FIGS. 2 and 3), whereas the passages adjacent the passage 10a, for example the passages 10b, have a plug 11b at the outlet end of the reactor body (on the right in FIGS. 2 and 3). As a result, on their path from the inlet to the outlet of the reactor body 8, the gases to be treated are constrained to pass through the walls separating the passages from each other in order for the particles that they contain to be retained and subsequently eliminated by regeneration.

According to one important feature of the invention, the reactor comprises a plurality of electrode beds 12 and 13, respectively, three of these electrode beds being visible in FIG. 3.

Each electrode bed 12 and 13 is formed of a plurality of parallel electrodes 14 arranged in the passages 10 of the support 8, each electrode comprising an electrically conductive material rod. In the embodiment represented, the diameter of an electrode is preferably slightly less than the length of the side of the section of a passage 10 of the carcass 9 to allow thermal expansion of the electrode.

The electrodes 14 of an electrode bed 12 or 13 are electrically connected to each other at one end by a transverse connecting bar 15, respectively 16. Each connecting bar 15 or 16 may be either simply in contact with the respective electrodes 12 or 13 or, where appropriate, welded or brazed to them. The transverse bars 15 and 16 are in turn in electrical contact with respective contact rods 17, respectively 18, which are situated laterally with respect to the reactor body 8 and by means of which the electrode beds 12 and 13 are connected to the positive pole 19 and to the negative pole 20, respectively, of a high-voltage source 21 by means of appropriate electrical conductors that are not represented in the drawings.

As a result, in the example represented, the electrode beds 12 form anode planes of the reactor and the electrode beds 13 form cathode planes. It will be noted that FIG. 3 shows only three electrode planes, but it will nevertheless be realized that this number is not limiting, a reactor body 8 being able to comprise a plurality of electrode beds, it being understood that a cathode plane is always situated between two anode planes, or vice versa. Only one anode plane co-operating with only one cathode plane may also be envisaged. As a general rule, the number of electrode planes is chosen as a function of several criteria, for example the value of the high voltage and the distance between two electrode planes of opposite polarity, which distance is itself determined by the volume of the reactor body, etc.

The transverse connecting bars 15 and 16 are accommodated in grooves 22 on the front of the end faces of the carcass 9. After installing each bed of electrodes, the grooves 22 are pointed with a ceramic paste 23, as, besides, the opposite ends of the passages 10 receiving the electrodes are plugged, also using a ceramic paste 24. This prevents the occurrence of untimely discharges at the corresponding faces caused by the spike effect.

As represented in the FIG. 2a detail view, the electrodes 14 of the anode and/or cathode electrode beds 12, 13 are preferably provided with helicoidal asperities or reliefs 25 running over the whole of their length. In the example represented, two of these helicoidal asperities are offset 180° relative to each other in the cross section of the electrode 14. These asperities are intended to encourage the spike effect in the regions of the reactor body 8 in which the gases are treated, i.e. where the corona discharges have to take place.

The material of the plugs 11a and 11b and the ceramic pastes 23 and 24 is preferably of low dielectric conductivity. This material is advantageously the same as that of the carcass 9, which avoids thermal expansion problems.

The high-voltage supply 21 may be designed to provide a direct current voltage that is applied continuously between the anode and cathode electrode beds 12 and 13. However, it has been found that the treatment of the gases may be encouraged and the energy transferred may be increased if the high voltage from the supply 21 is a pulsed voltage, the pulses preferably having a steep rising edge. For example, a pulse may be used whose slope may be a few kV/nanosecond, as shown in FIG. 10. Compared to a voltage that is applied continuously, a pulsed voltage supply optimizes the energy injected into the reactor, allowing peak voltage levels higher than the direct current breakdown voltage inherent to the carcass 9. The pulsed supply typically provides a minimum voltage from 10 to 40 kV, a pulse rising edge shorter than 10 ns, the shortest possible pulse width (less than a few hundred ns), and a repetition frequency from 1 Hz to 1 kHz, all of these values being given by way of example only. The power rating of the supply 21 is selected as a function of the number of discharges to be established between the electrode beds 12 and 13, the number of electrodes provided in each bed, the spacing between the electrode beds 12 and 13, the characteristics of the dielectric from which the carcass 9 is made, and the dielectric coefficient of the gaseous medium circulating in the filter.

FIG. 4 is a view analogous to that of FIG. 3 of an embodiment of a reactor used as a catalytic converter. In this case, the passages with no electrode beds 12 and 13 are open from one end to the other of the reactor body 8, with the result that the gases to be treated pass unimpeded through the whole of the reactor. On the other hand, the passages with electrodes are plugged at each end, as described with reference to the embodiment shown in FIGS. 2, 3 and 5.

In the embodiments shown in FIGS. 2, 3 and 5, on the one hand, and in FIG. 4, on the other hand, it is assumed that in each electrode bed 12 and 13 electrodes are provided in all the adjacent passages 10 situated in a common plane of the monolithic carcass 9. This arrangement achieves a maximum density of corona discharges in the reactor body 8 but necessitates a high electrical power.

The variant of the invention that is represented in FIG. 6 reduces the number of electrodes in each electrode bed by providing only one electrode in two in adjacent passages adapted to receive the anode and cathode electrodes beds 12 and 13, respectively. This being so, the density of the corona discharges is obviously lower, but in some instances may be sufficient to achieve sufficient treatment of the gases flowing through the reactor. The jagged line LB in the figure symbolizes a discharge.

In the FIG. 7 variant, the density of the corona discharges may be increased relative to that which can be achieved in the FIG. 6 arrangement by providing electrodes in one passage in two in two adjacent anode and cathode electrode beds 12 and 13, respectively, with the electrodes in the two beds arranged in a quincunx. In this arrangement, corona discharges may be established on two preferred paths, for example between two electrodes of the bed 12 and only one electrode of the bed 13. Corona discharges of this kind are symbolized by the jagged lines LB1 and LB2.

FIGS. 6 to 9 show two ways of plugging the passages at one end in the context of a reactor used as a particulate filter. In FIGS. 6, 7 and 8, it is assumed that the passages in the same plane of the reactor body 8 are plugged by plugs 11a and 11b situated alternately on one face of the body and the other face (this is also the case in the embodiment of FIGS. 2 and 3).

On the other hand, in the FIG. 9 variant, the passages 10 in the same plane P1 of the reactor body 8 are all plugged at the same end thereof, whereas those situated in an adjacent plane P2 are plugged at the opposite end.

1-18. (canceled)

19. Reactor for the plasma treatment of gas flows, in particular for treating exhaust gases produced by an internal combustion engine of an automobile vehicle, the reactor comprising a generally elongate reactor body (8) made from a dielectric material through which pass a plurality of parallel longitudinal passages (10), entry and exit means (6, 7) for conducting the flow of gas to be treated through said body (8), and electrodes (14) adapted to create corona discharges in said body to stimulate the treatment of said gas flow therein, wherein each of said electrodes (14) is disposed in a passage (10) of said plurality of passages (10) and extends over at least a portion of the length of the corresponding passage.

20. Reactor according to claim 19, wherein the passages (10) are disposed side by side in said reactor body (8) in superposed longitudinal planes, said electrodes (14) are arranged in at least two parallel electrode beds (12, 13), one of which comprises electrodes adapted to be connected to one pole of a high-voltage supply (21) and the other of which comprises electrodes adapted to be connected to the other pole of said high-voltage supply (21), and said electrode beds (12, 13) are offset from each other by a predetermined distance.

21. Reactor according to claim 20, wherein the ends of the electrodes (14) of the same electrode bed (12, 13) situated on the same front face of said reactor body (8) are connected in common to an electrically conductive bar (15, 16) connected to the corresponding pole of said high-voltage supply (21).

22. Reactor according to claim 21, wherein said connecting bar (15, 16) is disposed in a groove (22) formed in an end face of the reactor body (8).

23. Reactor according to claim 22, wherein said groove (22) receiving said connection bar (15, 16) is pointed using a dielectric material (23).

24. Reactor according to claim 21, wherein the end of each electrode (1′) opposite said connecting bar (15, 16) is buried in a dielectric material (14) plugging the passage (10) receiving that electrode at the corresponding end.

25. Reactor according to claim 20, which comprises at least three electrode beds (12, 13) and wherein the electrode bed or beds connected to one of the poles of said high-voltage supply (21) is or are disposed between two electrode beds connected to the other pole of said high-voltage supply (21).

26. Reactor according to claim 20, wherein the electrodes (14) of the two superposed adjacent electrode beds (12, 13) are disposed in passages (10) aligned in planes perpendicular to these electrode beds.

27. Reactor according to claim 20, wherein the electrodes (14) of two adjacent superposed electrode beds (12, 13) are inserted in respective passages arranged in a quincunx.

28. Reactor according to claim 19, wherein said electrodes (14) are rods, preferably of circular general section.

29. Reactor according to claim 28, wherein the rods of at least some of said electrodes (14) are provided with asperities or reliefs (25).

30. Reactor according to claim 29, wherein the asperities or reliefs (25) on the electrodes (14) extend therealong in accordance with a helicoidal profile.

31. Reactor according to claim 19, wherein said reactor body (8) is made from a ceramic such as cordierite.

32. Particulate filter which comprises a reactor according to claim 19 and wherein the passages (10) of said reactor body (8) with no electrodes (14) are alternately plugged at one or the other face (11a, 11b) of said body.

33. Particulate filter according to claim 32, wherein passages situated in two adjacent parallel planes (P1, P2) in said reactor body (8) are plugged at one or the other face (11a, 11b) of said body, respectively.

34. Particulate filter according to claim 32, wherein adjacent passages (10) situated in a common plane of said reactor body are alternately plugged at one and the other face (11a, 11b) of said body.

35. Particulate filter according to claim 32, wherein the walls of the passages are coated with a catalytic material.

36. Catalytic converter which comprises a reactor according to claim 19, wherein the passages (10) of the reactor body with no electrodes are open on both faces of the reactor body (8).
